(19) United States
(12) Patent Application Publication
(10) Pub. No.: US 2005/0199038 A1
(43) Pub. Date: Sep. 15, 2005

(54) Auto injector adapter for gas chromatograph

(76) Inventor: David J. Fritze, Baton Rouge, LA (US)

Correspondence Address: William R Coenen III;Kean Miller Hawthorne D'Armond, McCowan & Jarman, PO Box 3513, Baton Rouge, LA, 70821, US

(21) Appl. No.: 10/514,198

(22) PCT Filed: May 13, 2003
(86) PCT No.: PCT/US03/15062

§ 371 Date: Nov. 10, 2004

Related U.S. Application Data
(60) Provisional application No. 60/379,911, filed on May 13, 2002.

(51) Int. Cl. G01N 30/24

(52) U.S. Cl. 73/23.35

(57) ABSTRACT

A method and apparatus is disclosed for adapting auto injector devices to properly operate in conjunction with gas chromatographs that would previously have been incompatible. The invention consists of metal plates (10, 11, 12, 13) with circular apertures designed for placement over the injection port of the gas chromatograph. The plates are designed to align the chosen auto injector with the injection ports (30) and fix it in place. Also disclosed is the use of firmware to enable proper communication between the injector, the chromatograph, and the analysis and control software.

### TECHNICAL FIELD

This invention relates, generally, to gas chromatographs, and specifically to a compatibility adapter for an auto injector.

### BACKGROUND ART

Gas chromatographs are commonly used for industrial and forensic analysis, research at educational institutions, and other similar applications. Each chromatograph represents a significant investment, costing in some cases more than $50,000.

Due to the limited market for these devices, relatively few manufacturers exist. Each manufacturer uses its own proprietary system which in general is only compatible with parts made by that manufacturer.

This situation creates problems when a manufacturer ceases to make replacement parts for a given model of chromatograph. The failure of single part can make the entire apparatus inoperable, and the lack of a replacement makes the device useless. A common situation involves the failure of the chromatograph's auto injector, which is the portion of the chromatograph that controls the delivery into the chromatograph of samples to be tested.

Very few solutions exists for altering a chromatograph to be compatible with another company's auto injector. In one case, the injector consists of an arm that is trained to know the location of the injector port. However, this known design suffers from a serious drawback that makes it very undesirable for most applications. No means for proper communication between the auto injector and the chromatograph exists for this injector. When non-compatible auto injectors such as this one are used, the variables must be entered manually into the injector for each assay. In contrast, with compatible injectors the variable are automatically transmitted from the control software. Therefore, without proper communication, these injectors are only useful for a single application that is to be repeated over and over. It is simply too time-consuming to enter the many complex commands necessary to perform more than a small number of unique assays.

An apparatus that allows non-compatible auto injectors to communicate with the gas chromatograph's control software could significantly extend the useful life of a chromatograph and, due to the expensiveness of the chromatograph devices, would be quite desirable.

What is needed is an inexpensive and uncomplicated method and apparatus that can make newer model auto injectors compatible with any model of gas chromatograph.

### DISCLOSURE OF INVENTION

It is an object of the present invention to provide an apparatus capable of adapting an auto injector for attachment to a generally non-compatible gas chromatograph.

It is another object of the present invention to provide an apparatus capable of aligning an auto injector with the injection port of a gas chromatograph in a secure fashion.

It is another object of the present invention to provide a method for properly utilizing said apparatus.

It is another object of the present invention to provide such an apparatus that is durable yet inexpensive.

It is another object of the present invention to provide an apparatus that allows previously non-compatible auto injectors to communicate successfully with the control software of any gas chromatograph.

The present invention allows the use of auto injector devices with gas chromatographs that would generally be incompatible. Most gas chromatographs use a similar style injection port which theoretically can be used with any of the commercially available auto injectors. The difficulty arises due to the varying attachment, and alignment mechanisms utilized by gas chromatographs of varying manufacture. Also, the unique language used by each chromatograph creates a practical barrier to the successful use of non-compatible auto injectors.

The present invention is particularly useful for allowing various makes of auto injectors to be used with various makes of gas chromatographs, some of which may no longer be supported by their manufacturer. Without the present invention it may be necessary to discard an older gas chromatograph simply because its auto injector is no longer functional. Because the auto injector represents a small portion of the total cost of a gas chromatograph, this is not an economic solution. The apparatus and method of the present invention allows a purchaser to replace the nonfunctional auto injector with a newer model that ordinarily could not be used with the older model gas chromatograph. The present invention also allows a purchaser to match an auto injector of one maker with a gas chromatograph of another on the initial purchase there by achieving acceptable or even optimal performance at the best price. Further, the invention allows the full use of the new auto injector as though it were designed to be fully compatible.

### BRIEF DESCRIPTION OF THE DRAWINGS

FIG. 1 is a drawing of a base plate.

FIG. 2 is a drawing of a front plate.

FIG. 3 is a drawing of a rear plate.

FIG. 4 is a drawing of a sliding plate.

FIG. 5 is a drawing of an alignment tool.

FIG. 6 is a drawing of the mounting apparatus prior to installation of the auto injector.

### BEST MODE FOR CARRYING OUT INVENTION

The present invention is an apparatus and method useful for adapting auto injector devices to generally non-compatible gas chromatographs. The embodiment shown in the figures is specifically designed to mate the Shimadzu model AOC-20i Auto Injector with the Agilent 5890 Series of Gas Chromatograph. Modifications to the apparatus as described herein can be easily made in most instances to allow for the use of any model auto injector with any model of chromatograph.

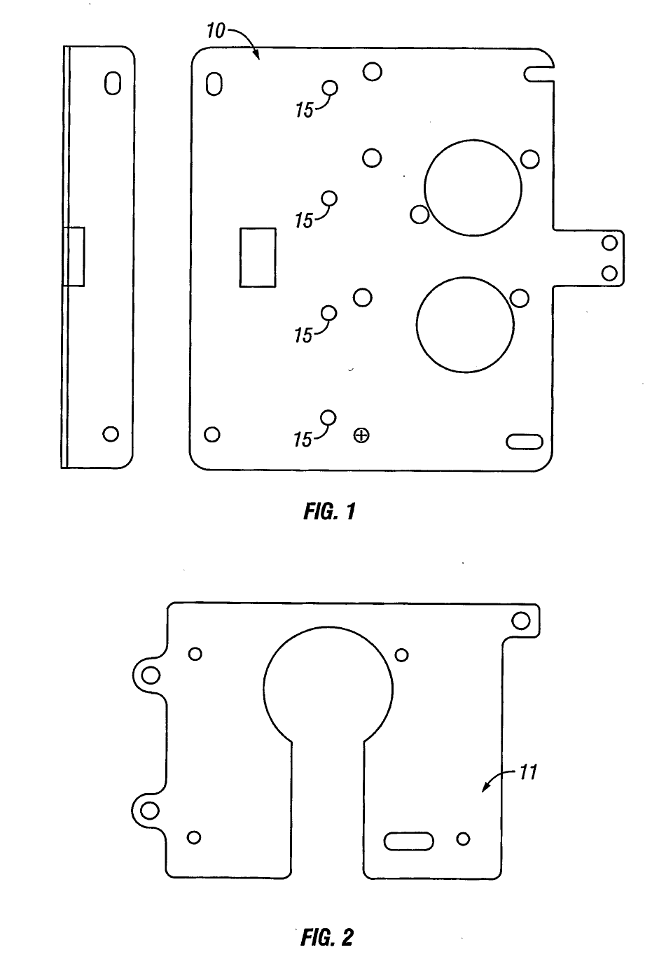

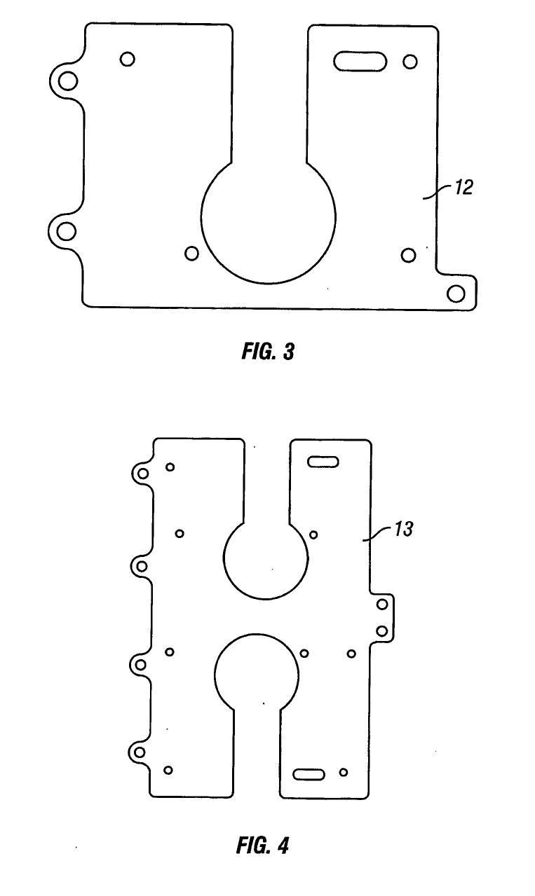

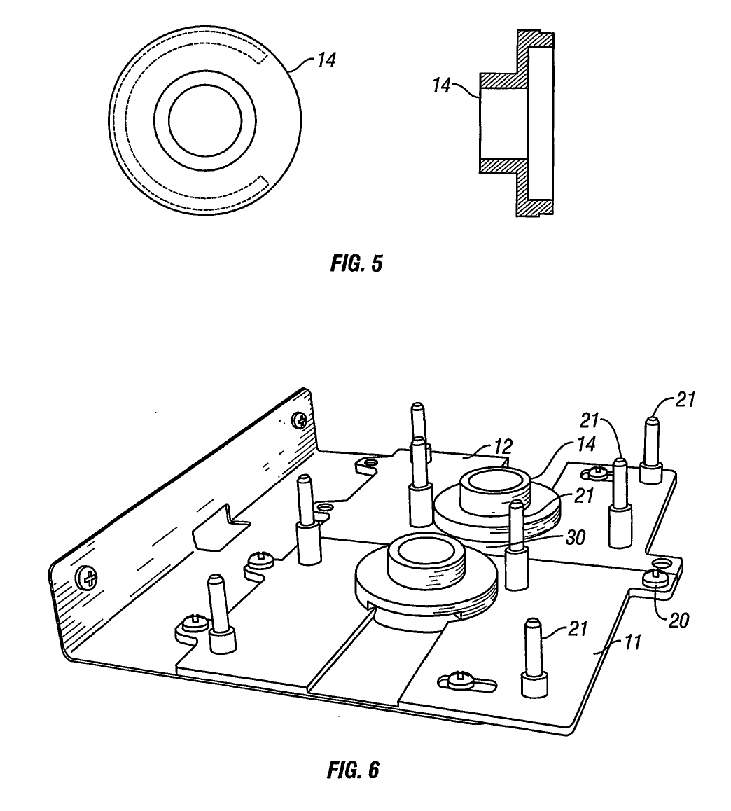

FIGS. 1-3 depict base plate 10, front plate 11, and rear plate 12, respectively, used for mounting a dual injector configuration auto injector in one embodiment of the invention. FIG. 4 shows sliding plate 13 which is used in single injector configurations. FIG. 5 shows a design of alignment tool 14 used to correctly center the auto injector above the injector port. Finally FIG. 6 shows the plates as assembled with standoffs 20, mounting pins 21, and alignment tool 14 just prior to the installation of the auto injector. Also shown in FIG. 6 is injector port 30 on the chromatograph.

Base plate 10 is secured to the chromatograph such that its apertures are centered over injection ports 30. Any suitable method may be used to fasten base plate 10 in place, although in the embodiment shown, mounting screw holes 15 will align with holes on the chromatograph and on the plates, making mounting screws the preferred option. Base plate 10 is also shown in FIG. 6 spaced from the surface of the chromatograph by standoffs 20.

Allowing the use of a non-compatible auto injector with a gas chromatograph is a significant achievement. However, it is the further addition of a translator device that makes the present invention truly remarkable. A standard chromatograph has a built-in controller and a distribution hub that routes signals to allowable devices such as injectors, a carousel, etc. The chromatograph is also generally connected to a computer that runs controller software. It is the software that tells the chromatograph exactly what steps to take to properly perform the assigned assays. The variables input, such as the number of samples, the number of rinse washes, the viscosity of the sample, injection speeds, etc. will vary from assay to assay.

The primary difficulty when dealing with a non-compatible injector is that the controller software is designed for the specific model of chromatograph and will not communicate properly with the injector, which has its own controller—generally an embedded microprocessor. Therefore, the instructions must be manually input, which is prohibitively time consuming for most applications. The addition of a translator device provides the functionality that one gets from using an injector that was built to be compatible with the given model of chromatograph.

The translator essentially runs software that converts the communication language of the chromatograph to that of the injector being used. In one embodiment, the software is encoded into firmware. In practice, when the chromatograph is connected to the injector, it attempts a “handshaking” to determine compatibility. The commands originating with the chromatograph's controller software are then sent to the injector. When the translator device is used, it is placed in the circuit between the chromatograph and the injector to facilitate this communication. All commands received from the chromatograph in the translator device are converted by its software (whether in firmware, hardware, or true software form) into the language used by the auto injector. Each combination of models of chromatograph and injector will have a different instruction set for conversion, but the variations will be minor. It is also possible that a translator device could support multiple combinations of devices with multiple instruction sets built into its program.

It is not necessary that the present invention be practiced with the mounting apparatus as described herein. In one embodiment, the invention combines any means for securing an injector in place, such as that described herein, another configuration of plates, any suitable bracket, or any other method that allows the injector to maintain its position relative to the chromatograph, with the translator device and any connecting equipment that is necessary. The translator allows for use of the injector with the control software designed for the specific gas chromatograph model.

As mentioned above, the steps outlined below are for a specific model auto injector and gas chromatograph. The positions of the various holes and sizes of the various plates, pins, and attachment screws can be altered to make the invention capable of adapting almost any combination of auto injector and chromatograph. The following installation procedure is suitable for the embodiment of the invention shown in the figures.

First, base plate 10 should be mounted on the chromatograph using standoffs 20 and the mounting screws (not shown). The apertures should be centered over injection ports 30 if mounting screw holes 15 are properly aligned with the corresponding holes in the chromatograph. If any split inlet tubing is routed to injection port(s) 30, it should be removed at this point in the installation.

Second, mounting pins 21 should be inserted into front plate 11 and rear plate 12. The design of mounting pins 21 will be determined by the configuration of the chromatograph and the injector. Once the pins are correctly positioned, the plates can be mounted to base plate 10 and properly aligned. Rear plate 12 should be installed first to minimize the difficulty of installation. Once rear plate 12 is in place, alignment tool 14 can be installed. The septa nut should fit closely inside the inner diameter of alignment tool 14. Alignment tool 14 should be also seat in rear plate 12 and at this point will not move. The opening in alignment tool 14 should be aligned with the channel in rear plate 12 so that gas lines may be routed through if needed. Front plate 11 should be installed in a similar manner. At this point, the apparatus should appear as in FIG. 6. If a single injector tower is being used, sliding plate 13 shown in FIG. 4 will be used in place of front plate 2 and rear plate 3. The installation procedure is approximately the same.

Third, the auto injectors should be installed, preferably from rear to front. The rear injector should be mounted on mounting pins 21 facing the rear. Alignment tool 14 should fit tightly into the bottom of the injector, and installation is complete. Next, the front injector should be mounted facing to the front of the chromatograph.

At this point the cables are ready to be connected to the system. A suitable place for the injector controller should be found and power should be turned off. The cables from the injectors should be connected to the appropriate ports in the controller. Finally, the cable from the injector controller to the chromatograph should be connected.

The next step is to connect and configure the translator device. This step will vary depending on the models of chromatograph and injectors being used. If the software package being used utilizes a different communication protocol than the chromatograph, a converter can be used. The baud rate setting for the translator device should be configured to match that of the work station it is connected to. Similarly, the communication protocol should be specified on the translator device. These configuration settings may also have to be set on the auto injector itself, as well as in the software setup. Other settings or configurations should be modified as needed based on the equipment being used. For instance, with the Shimadzu model AOC-20i Auto Injector, the sample racks may have to be modified slightly.

Another improvement involves the use of a bracket for securing a carousel to a gas chromatograph of a different manufacturer. The typical carousel has a robot arm that is capable of remembering its position in space. Therefore, the bracket would merely have to be capable of being secured to the carousel, and an attachment means for attaching the bracket to the gas chromatograph must be included at a convenient location within the reach of the robot arm. These attachments could be made with screws, bolts, cams, or any other means well known in the art.

There are of course other alternate embodiments that are obvious from the foregoing descriptions of the invention, which are intended to be included within the scope of the invention, as defined by the following claims.

1. An apparatus for mounting an auto injector on a gas chromatograph comprising:
a base plate having at least one aperture;
a sliding plate having at least one aperture; and
mounting fasteners.

2. The apparatus of claim 1 wherein said sliding plate is a rear mounting plate and said apparatus further comprises a front mounting plate.

3. The apparatus of claim 1 further comprising an alignment tool.

4. The apparatus of claim 1 wherein said base plate is spaced from said gas
chromatograph by at least one standoff.

5. The apparatus of claim 1 wherein said auto injector is mounted to said sliding plate with pins.

6. The apparatus of claim 5 further comprising an alignment tool.

7. An auto injector conversion kit comprising:
means for securing an auto injector to a gas chromatograph; and,
a translator device.

8. The conversion kit of claim 7 wherein said translator device comprises
firmware.

9. The conversion kit of claim 7 further comprising a bracket for attaching a carousel to said gas chromatograph.
